(19) United States
(12) Patent Application Publication
(10) Pub. No.: US 2006/0061900 A1
(43) Pub. Date: Mar. 23, 2006

(54) Magnetic recording medium, magnetic storage device, and fabricating method thereof

(75) Inventors: Yoshinori Ohtsuka, Kawasaki (JP); Ken-ichi Itoh, Kawasaki (JP); Hiroshi Nakao, Kawasaki (JP); Hideyuki Kikuchi, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/018,525

(22) Filed: Dec. 21, 2004

(30) Foreign Application Priority Data
Sep. 3, 2004 (JP) 2004-257471

(51) Int. Cl. G11B 5/65; G11B 19/02

(52) U.S. Cl. 360/69; 428/836.1

(57) ABSTRACT

A magnetic recording medium has a recording layer (42) formed over the substrate. The recording layer is structured by a nonmagnetic base, and a plurality of magnetic dots formed in the nonmagnetic base. The magnetic dots are aligned in a prescribed direction in each track or each group of adjacent tracks of the magnetic recording medium. In a preferred example, the magnetic dots align in a direction tilting at a prescribed angle with respect to the width of the track.

### BACKGROUND OF THE INVENTION

1. Field of the Invention

The present invention generally relates to a magnetic recording medium and a magnetic storage device using the magnetic recording medium. The present invention also related to fabrication of such a magnetic recording medium and a magnetic storage device.

2. Description of the Related Art

In recent years and continuing, large-capacity magnetic data storages over 100 GB have become mainstream, responding to demand for recording video images (or moving images). One example of such a large-capacity magnetic storage is a magnetic disk device, which is loaded in personal computers or domestic home video recorders. It appears that demand for large-capacity and low-price magnetic disk devices will continuously increase in the future. As for the in-plane recording method currently employed in magnetic disk devices, it is said that 200 gigabits per square inch is the technical limit on the surface recording density.

To overcome the technical limit, so-called patterned media are proposed for the purpose of reducing the magnetic interaction caused in the conventional successive recording thin films and miniaturizing the unit of record. Examples of the pattered medium are disclosed in JP 2004-039015A, JP 2002-175621A, JP 2003-109333A, and JP 2003-157503A.

In a patterned medium, fine unit regions of a ferromagnetic material (referred to as “magnetic dots”) are arranged in a prescribed order on the surface of the recording layer. The interval between magnetic dots is set constant so as to reduce the magnetostatic interaction or exchange interaction. It is expected, with patterned media, that a high S/N ratio is to be achieved even in high-density recording.

The recording density of a patterned medium can be increased by reducing the number of those dots for recording one-bit information, as well as reducing the size and the interval of the magnetic dots. In addition, by reducing the area size of the sensor (reproducing) element in the magnetic head for detecting magnetic leakage flux from the magnetic dots, the information written in the magnetic dots is read in minute detail.

However, with this arrangement, the number of magnetic dots with leakage flux detectable by the sensor decreases. In addition, since the magnetic dots are positioned at a certain interval, detection of the maximum leakage flux from the individual magnetic dots is likely to deviate in time. As a result, the entirety of the maximum magnetic leakage flux detected from a group of magnetic dots defining one-bit information decreases, and the reproduction output and the S/N ratio are degraded.

### SUMMARY OF THE INVENTION

The present invention was conceived to overcome the above-described problems in the prior art, and it is an object of the present invention to provide a magnetic recording medium, a magnetic storage device, and fabricating method thereof, which enable high-density magnetic recording operations.

To achieve the object, in one aspect of the invention, a magnetic recording medium is provided. The magnetic recording medium comprises a substrate and a recording layer formed over the substrate. The recording layer is structured by a nonmagnetic base and a plurality of magnetic dots formed in the nonmagnetic base. The magnetic dots are aligned in a prescribed direction for each track or each group of adjacent tracks of the magnetic recording medium.

With this arrangement, the maximum magnetic leakage flux is detected simultaneously from a plurality of magnetic dots, and the reproduction output is increased, while reducing the half-value width of the reproduced waveform. Consequently, high-density recording is achieved.

In a preferred example, the magnetic dots align in a direction tilting at a prescribed angle with respect to the width of the track.

Each of the magnetic dots is of a nano-scale and extends substantially perpendicular to a surface of the nonmagnetic base.

In another aspect of the invention, a magnetic storage device is provided. The magnetic storage device comprises a magnetic recording medium having a recording layer in which a plurality of magnetic dot are formed in a nonmagnetic base, and a magnetic head having a sensor element for detecting information from the magnetic dots. The magnetic dots are aligned in a direction consistent with a width direction of the sensor element of the magnetic head in each track or each group of adjacent tracks.

With this arrangement, the sensor element of the magnetic head can detect magnetic leakage flux from multiple magnetic dots simultaneously. Accordingly, the magnetic storage device can have a high reproduction output level, based on a high-density recording medium.

In still another aspect of the invention, a method for fabricating a magnetic recording medium is provided. The method comprises the steps of:
(a) forming a nonmagnetic layer over a substrate;
(b) forming a groove pattern in the nonmagnetic layer, the groove pattern consisting of a plurality of grooves, each groove having a longitudinal axis extending in a prescribed direction;
(c) forming one or more nanoholes in each of the grooves along said longitudinal axis such that each of the nanoholes extends substantially perpendicular to a top face of the nonmagnetic layer; and
(d) filling each of the nanoholes with a magnetic material.

With this method, a pattern of magnetic dots aligned in a desired direction is fabricated easily in each of the grooves. The time and cost required for forming the grooves are reduced.

### BRIEF DESCRIPTION OF THE DRAWINGS

Other objects, features, and advantages of the present invention will become more apparent from the following detailed description when read in conjunction with the accompanying drawings, in which:

FIG. 1A and FIG. 1B are schematic diagrams illustrating formation of nanoholes according to an embodiment of the present invention;

FIG. 2 is a plan view of a magnetic storage device according to an embodiment of the invention;

FIG. 3A is a schematic cross-sectional view of a magnetic head and a magnetic disk, and FIG. 3B is a plan view of the magnetic head positioned over the magnetic disk;

FIG. 4A through FIG. 4C are cross-sectional views of other examples of the magnetic disk;

FIG. 5 is a plan view of the recording layer of the magnetic disk, showing the positional relation between the magnetic-dot array and the sensor element;

FIG. 6 is a plan view of the recording layer of the magnetic disk, showing another example of the positional relation between the magnetic-dot array and the sensor element;

FIG. 7 is a plan view of the recording layer of the magnetic disk, showing still another example of the positional relation between the magnetic-dot array and the sensor element;

FIG. 8A is a graph of skew angle as a function of radial position, and FIG. 8B is a graph of normalized reproduction output as a function of radial position, both of which are used to explain problems residing in the conventional magnetic storage device;

FIG. 9A through FIG. 9F illustrate the manufacturing process of a magnetic disk according to an embodiment of the invention;

FIG. 10 is a plan view of the groove pattern formed in the metal layer of the magnetic disk according to an embodiment of the invention;

FIG. 11 is a plan view of a modification of the magnetic dot array formed in a servo region of the magnetic disk according to an embodiment of the invention;

FIG. 12 is a plan view of another example of the groove pattern formed in the metal layer in the servo region;

FIG. 13 is a plan view showing another modification of the magnetic dot array formed on the magnetic disk according to an embedment of the invention; and

FIG. 14 is a plan view of still another example of the groove pattern formed in the metal layer.

### DETAILED DESCRIPTION OF THE PREFERED EMBODIMENTS

The preferred embodiments of the present invention are now described below with reference to the attached drawings.

First, explanation is made of the basic idea of the present invention. The inventors of the present invention found that alumite pores (which are openings or holes extending substantially perpendicular to the surface of an aluminum layer) can be created in a groove formed in the aluminum layer through an anodizing process under prescribed conditions, including a voltage level. The inventors also found that formation of pores is restrained in a flat area in which no grooves are formed. This means that alumite pores can be formed selectively by providing grooves in an aluminum layer (which is converted to an aluminum oxide layer by the anodizing process).

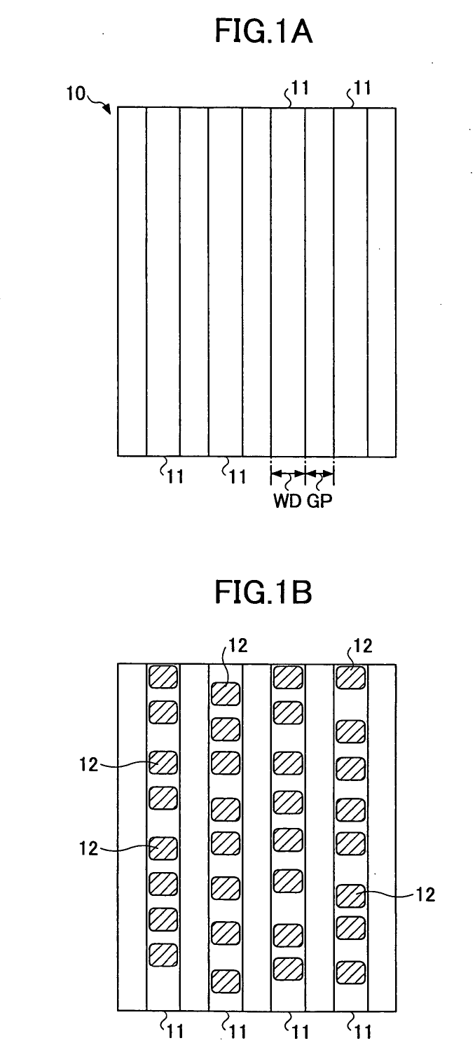

FIG. 1A and FIG. 1B schematically illustrate formation of nanoholes, which are depicted based on SEM images. In FIG. 1A, concentric grooves 11 are formed in an aluminum layer 10 (with a thickness of 100 nm) over a disk substrate by imprint pattern transfer. The width (WD) of the groove is 60 nm, and the gap (GP) between adjacent grooves is 40 nm. Then, an anodizing process is carried out under voltage application of 25 V. Through the anodizing process, alumite pores 12 are formed in the grooves 11 at a substantially constant interval (about 60 nm), while no holes are formed in the gap regions (GP), as illustrated in FIG. 1B. The interval of the nanoholes slightly varies in the drawing; However, it is confirmed that the regularity of the nanohole interval increases when decreasing the length of the groove and that the same number of nanoholes are formed in the same length grooves.

This experimental result indicates that a number of magnetic dots can be produced, being arranged regularly in a prescribed array, at high controllability. This can be applied to a magnetic recording medium of high recording density.

Making use of this phenomenon, magnetic dots are aligned in a prescribed direction, for example, in the direction of the track width of the sensor in the magnetic head, for each track or each group of tracks, and accordingly, the magnetic leakage fluxes from the magnetic dots can be simultaneously detected. This allows the reproduction output to rise, while narrowing the half-value width of the reproduced waveform, and high density recording is achieved.

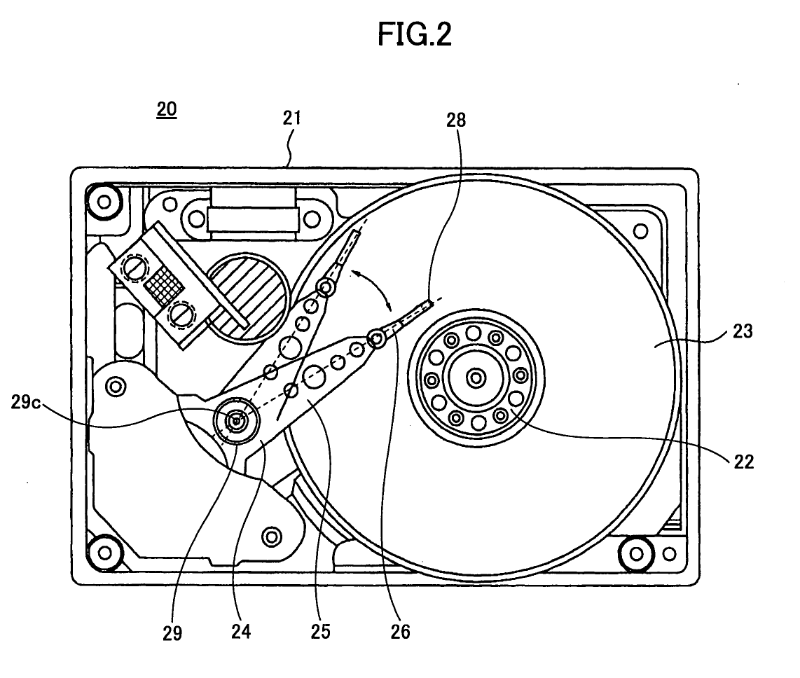

FIG. 2 is a plan view of the major part of a magnetic storage device 20 according to an embodiment of the invention. The magnetic storage device 20 of this embodiment is both readable and writable, and it includes a housing 21, a hub 22 rotated by a spindle (not shown), a magnetic disk 23 fixed by the hub 22, and a magnetic head 28 held by an arm 25 and a suspension 26. The magnetic head 28 moves in the radial direction of the magnetic disk 23, being rotated about the center axis 29c of the bearing unit 29 included in the actuator unit 24. The magnetic head 28 accesses each track (not shown) of the magnetic disk to record and reproduce data.

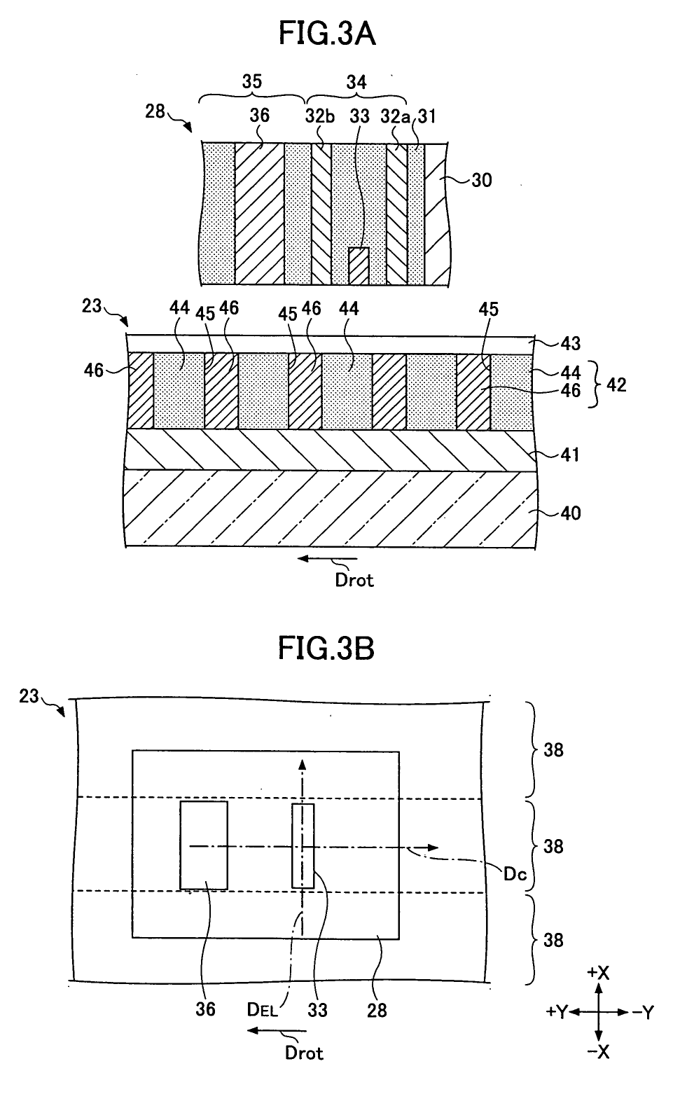

FIG. 3A is a cross-sectional view of the magnetic head 28 positioned over the magnetic disk 23, and FIG. 3B is a corresponding plan view.

The magnetic head 28 is of a combination type having both a reading head 34 and a single-pole recording head 35 formed on an AlTiC (Al₂O₃.TiO₂) slider 30. The reading head 34 has a sensor element 33 embedded in an aluminum oxide insulating layer 31 sandwiched between shield layers 32a and 32b made of a soft magnetic material. The sensor element 33 is, for example, a giant magneto resistive (GMR) element.

The single-pole recording head 35 has a major magnetic pole 36 made of a soft magnetic material for applying a magnetic flux to the magnetic disk 23, a return yoke (not shown) magnetically connected to the major magnetic pole 36, and a recording coil (not shown) for inducing the recording magnetic flux to the major magnetic pole 36 and the return yoke. Preferably, the major magnetic pole 36 is made of a magnetic material with a high saturated magnetic flux density, such as 50% Ni-50% Fe alloy, FeCoNi alloy, FeCoNiB, or FeCoAlO. By using these materials, high-density magnetic flux can be concentrated on the magnetic disk 23, preventing magnetic saturation.

The GMR element used as the reading element 33 has a spin-valve structure and detects the direction of the magnetic flux leakage from the dots, representing information recorded in the magnetic disk 23, as change in resistance. In place of the GMR element, a ferromagnetic tunnel junction MR (TMR) element or a ballistic MR element may be used.

The magnetic disk 23 has a soft magnetic backing layer 41, a recording layer 42, and a protection layer 43 deposited in this order on a substrate 40. The recording layer 42 comprises a nonmagnetic base 44 and magnetic dots 46 located in prescribed positions in the nonmagnetic base 44. The magnetic dots 46 are fabricated by filling nanoholes (openings) 45 extending perpendicular to the base surface with a magnetic material.

The substrate 40 is, for example, a crystallized glass substrate, a reinforced glass substrate, a silicon (Si) substrate, an aluminum alloy substrate, or a plastic substrate.

The soft magnetic backing layer 41 has a thickness ranging from 50 nm to 2 μm, and is made of an amorphous or microcrystal alloy containing at least one element selected from Fe, Co, Ni, Al, Si, Ta, Ti, Zr, Hf, V, Nb, C, and B, or alternatively, layers of these alloys. From the viewpoint of concentrating the magnetic flux from the major magnetic pole during the recording operation, it is preferable to use a soft magnetic material with the saturated magnetic flux density at or above 1.0 T and with the coercivity (Hc) at or below 790 kA/m. To be more precise, the soft magnetic backing layer 41 is made of, for example, NiFe (Permalloy), FeSi, FeAlSi, FeC, FeTaC, FeCoB, FeCoNiB, CoNbZr, CoCrNb, NiFeNb, or NiP. The soft magnetic backing layer 41 is provided in order to absorb almost all the magnetic flux generated from the recording head 35. To record data in the recording layer 42 in the saturated state, it is preferable that the product of the saturated magnetic flux density and the film thickness be large. From the viewpoint of high-rate recording operation, it is preferable for the soft magnetic backing layer 41 to have a high magnetic permeability with respect to high frequencies. The soft magnetic backing layer 41 may be omitted depending on the specification of the magnetic head 28.

The thickness of the soft magnetic backing layer 41 is at or below 500 nm, preferably, at or below 300 nm, and more preferably, in the range from 20 nm to 200 nm. Exceeding 500 nm, high-density recording operation may not be achieved, and the recording layer may have to be polished. In this case, extra cost and time are required, and the recording quality may also be degraded.

The nonmagnetic base 44 may be made of an arbitrary nonmagnetic material. If the nanoholes 45 are alumite pores, aluminum oxide is used.

The nanoholes penetrate the nonmagnetic base 44. The size and the interval of the nanoholes 45 are appropriately selected based on the recording density of the magnetic disk 23 and/or the specification of the magnetic head 28. The fabrication process of the nanoholes 45 is described later.

The interval of nanoholes 45 formed in an area of the magnetic dot array ranges from 5 nm to 500 nm, and the range from 10 nm to 200 nm is more desirable. Below 5 nm, it becomes difficult to form nanoholes 45. Above 500 nm, regularity of nanohole alignment cannot be achieved.

The diameter of the nanohole 45 is sufficiently small so as to define a magnetic dot as a single magnetic section. Preferably, the diameter is less than or equal to 200 nm, and more preferably, 5 nm to 100 nm. If the diameter of the nanohole 45 exceeds 200 nm, the magnetic dot may not define a single magnetic section.

The aspect ratio (which is the ratio of the depth to the diameter) of the nanohole 45 may be appropriately selected, without restrictive limitations. However, a high aspect ratio is desirable because the anisotropism in shape increases and the vertical coercivity of the magnetic dot (generated perpendicular to the substrate) is improved. For example, the aspect ratio is greater than or equal to 1, and preferably, 2 to 15.

The magnetic dot 46 is made of a so-called perpendicularly magnetized thin film with an easy magnetization axis perpendicular to the substrate, which is made of a material selected from the group consisting of Fe, Co, Ni, Fe-based alloy, Co-based alloy, and Ni-based alloy. The thickness of the perpendicularly magnetized thin film is, for example, 5 nm to 100 nm. Examples of the magnetic material include Fe, Co, Ni, FeCo, FeNi, CoNi, FeCoNi, and CoNiP. The thickness of the magnetic dot 46 is preferably 5 nm to 50 nm. Since the magnetic dot 46 is surrounded by the nonmagnetic base 44, the magnetic flux generated from the recording head 35 focuses on the magnetic dot 46, preventing undesirable divergence during the recording operation. The thickness of the magnetic dot 46 can be set greater than that of a successive thin-film recording layer of a vertical magnetic recording medium.

The magnetic material of the magnetic dot 46 may also be selected from cobalt (Co) based alloys, including CoPt, CoCrTa, CoCrPt, CoPt-M, and CoCrPt-M, where M is chosen among B, Mo, Nb, Ta, W, Cu and their alloys. These magnetic materials are preferable from the viewpoint of controllability of saturated magnetization and magnetic anisotropy constant. Examples of such Co-based alloys include CoNiCr, CoCrPtB, CoCrPtTa, and CoCrPtTaNb. The magnetic material used for the magnetism dots 46 may be a regularized alloy, such as FePt or CoPt.

The protection layer 43 has a thickness of 0.5 nm to 5 nm, and it is made of amorphous carbon, hydrogenated carbon, carbon nitride, aluminium oxide, or zirconia.

The surface of the protection layer 43 may be coated with a lubrication layer. The lubrication layer is applied onto the protection layer 43 up to a thickness of 0.5 nm to 5 nm by a pulling method or spin coating. The lubrication layer may be made of a lubricant containing Per fluoro-polyether as the principal chain. The lubrication layer is not essential for the present invention, and it may or may not be provided, depending on the material of the protection layer 43 and the specification of the magnetic head 28.

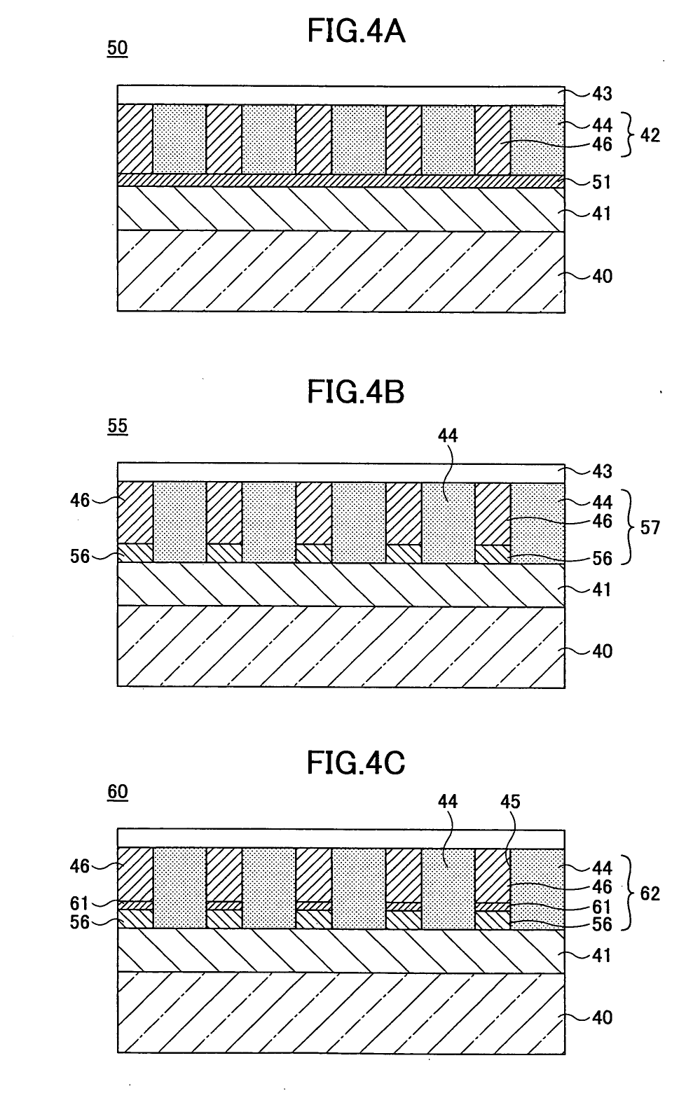

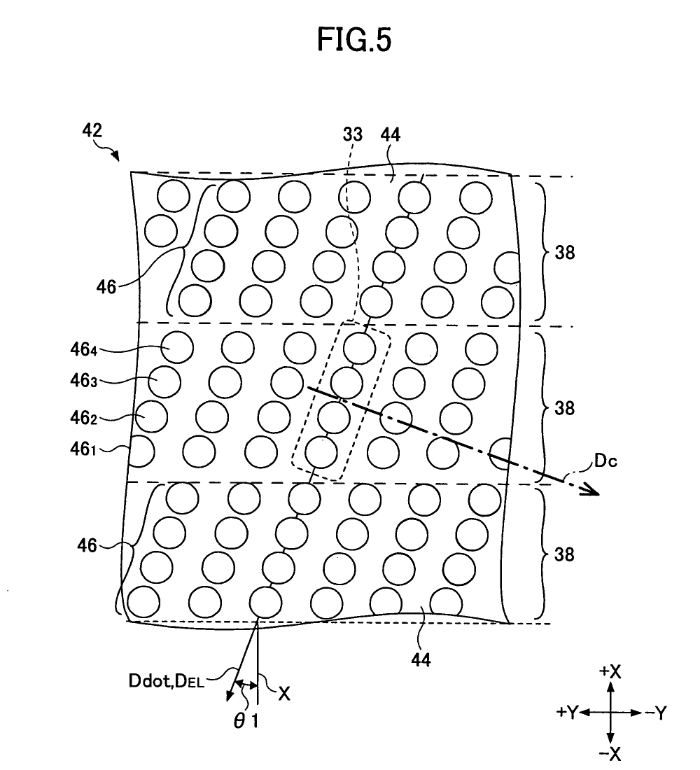

FIG. 4A through FIG. 4C are cross-sectional views illustrating other structural examples of the magnetic disk. In FIG. 4A, a nonmagnetic layer 51 is inserted between the soft magnetic backing layer 41 and the recording layer 42 of the magnetic disk 50. The nonmagnetic layer 51 has a thickness of 1.0 nm to 10 nm, and is made of a nonmagnetic material selected from a group consisting of Cu, Al, Cr, Pt, W, Nb, Ru, Ta, Ti, Mo, C, Re, Os, Hf, Mg and these alloys. Among them, it is preferable to use Cu, Al, Cr, Pt, W, Nb, Ru, Ta, Ti or these alloys because these materials allow the magnetic dots 46 to be formed by electroplating, as is described below. By inserting the nonmagnetic layer 51 between the soft magnetic backing layer 41 and the recording layer 42 with magnetic dots 46, magnetic interaction can be prevented, and adverse effect of the soft magnetic backing layer 41 on the growth of the magnetic dots 46 can be removed.

In the example shown in FIG. 4B, a soft magnetic layer 56 is provided under the bottom of the magnetic dot 46 of the magnetic disk 55. The soft magnetic layer 56 has a thickness of 1.0 nm to 10 nm, and is made of the same material as the soft magnetic backing layer 41. By inserting the soft magnetic layer 56 under the bottom of the magnetic dot 46, the distance (spacing) between the sensor (or reproducing) element 33 (shown in FIG. 3A) and the top face of the soft magnetic material can be reduced, and the spacing loss is reduced.

In the example shown in FIG. 4C, an intermediate nonmagnetic layer 61 is further inserted between the magnetic dot 46 and the soft magnetic layer 56. The intermediate nonmagnetic layer 61 has a thickness of 1.0 nm to 10 nm, and it may be made of the same material as the nonmagnetic layer 51 used in the example of FIG. 4A.

Returning to FIG. 3B, the magnetic head 28 is placed over the track 38 of the magnetic disk 23 with an air gap between them. The magnetic disk 23 rotates in the direction indicated by the arrow Drot, and the sensor element 33 of the magnetic head 28 reproduces information from the magnetic dots 46 (not shown in FIG. 3B) formed in the track 38.

In FIG. 3B, the +X direction is on the inner circumferential side of the magnetic disk 23, and the −X direction is on the outer circumferential side thereof. The +Y direction is in the rotating direction of the magnetic disk 23. The rotational center for driving the magnetic head 28 (that is, the center 29c of the bearing unit 29 shown in FIG. 2) is located in the direction Dc, and the width direction of the sensor element 33 is indicated by the arrow D_{EL}. The directions Dc and D_{EL} are perpendicular to each other in the embodiment; however, the present invention is not limited to this arrangement. The configuration shown in FIG. 3B applies to FIG. 5 through FIG. 7 and FIG. 11 through FIG. 15.

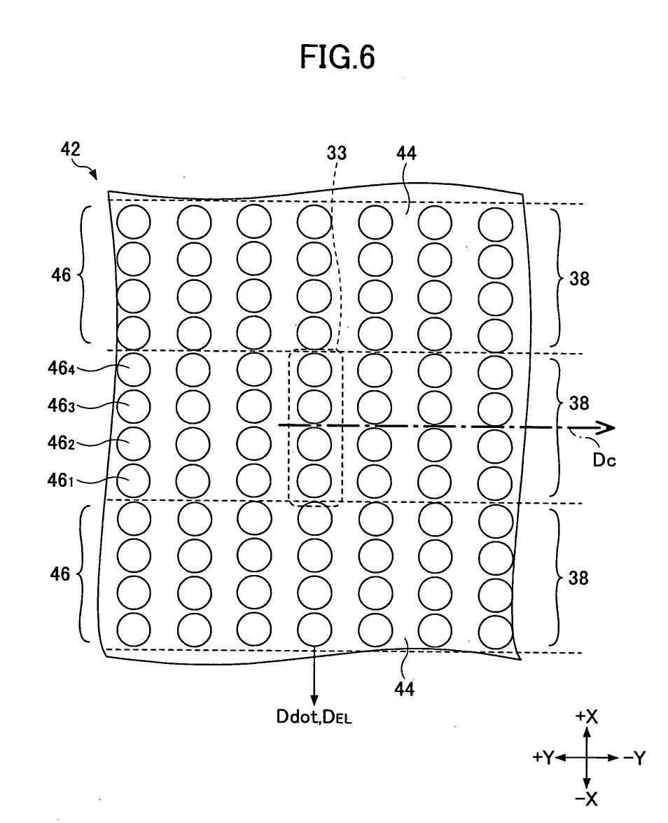

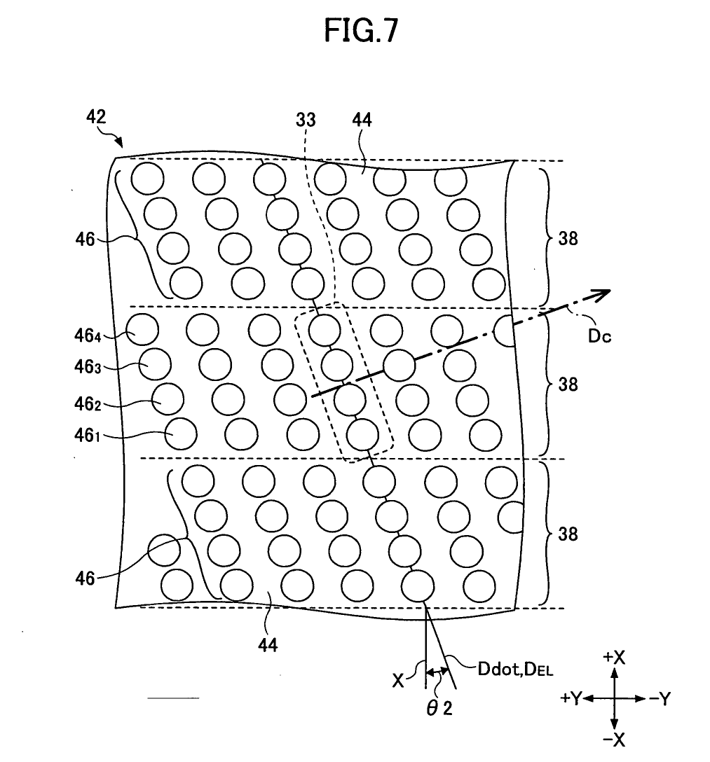

FIG. 5 through FIG. 7 illustrate the positional relation between the magnetic dot array and the sensor element 33 moving over the magnetic disk 23. FIG. 5 shows three inner tracks, FIG. 6 shows three middle tracks, and FIG. 7 shows three outer tracks of the magnetic disk 23, in which the magnetic dots 46 are arranged in a prescribed manner. In these figures, only the sensor element 33 is depicted by the dashed line, and the outline of the magnetic head 36 is omitted. The protection layer 43 covering the recording layer 42 of the magnetic disk 23 is also omitted from this plan view.

In FIG. 5 through FIG. 7, four magnetic dots 46 align across the width of the track 38 of the recording layer 42 in the dot aligning direction Ddot. The dot aligning direction Ddot agrees with the width direction D_{EL} of the sensor element 33. By arranging the magnetic dots 46 such that a line of magnetic dots 46 aligns along the width of the sensor element 33, the sensor element 33 can simultaneously detect the magnetic leakage flux from four magnetic dots 46 arranged across the track 38. The simultaneous detection of magnetic leakage flux increases the reproduction output, while narrowing the half-value width of the reproduced waveform, and high recording density can be achieved. Even though the position of the sensor element 33 slightly shifts in the direction of the track width, the reproduction output can be maintained without abrupt fall.

The dot aligning direction Ddot tilts at a certain angle with respect to the track width (along the X axis). The tilting angle θ1 between the dot aligning direction Ddot and the width of the track 38 varies along with the motion of the magnetic head 28 over the magnetic disk 23. For example, the tilting angle θ1 changes depending on whether the magnetic head 28 is located in the inner circumference (FIG. 5), the middle circumference (FIG. 6), or the outer circumference (FIG. 7). This is because the width direction D_{EL} of the sensor element 33, which is consistent with the dot aligning direction Ddodt of the magnetic dots 46, varies with respect to the width of the track 38 along the X axis as the magnetic head 28 rotates about the center 29c of the bearing unit 29 of the actuator. The lines of magnetic dots 46 extend parallel to each other across the track 38 or across a group of tracks 38 (e.g., three tracks shown in FIG. 5). Although FIG. 5 through FIG. 7 depict the positional relation between the magnetic dots 46 extending in direction Ddot and the sensor element 33 extending in the width direction D_{EL} at specific positions on the magnetic disk 23, this positional relation applies to an arbitrary location on the entire area of the magnetic disk 23.

The width direction D_{EL} of the sensor element 33 continuously varies with respect to the width of the track 38 as the magnetic head 28 moves. The aligning direction Ddot of the magnetic dots 46 may be set for every track 38 or every group of tracks 38. If the number of tracks included in a group increases, the dot aligning direction Ddot of the magnetic dots 46 slightly deviates from the width direction D_{EL} of the sensor element 33. The acceptable range of deviation is selected appropriately based on the reproduction output level, the diameter of the magnetic dot 46, or the thickness (or the height) of the sensor element 33 extending perpendicular to the width direction DEL thereof.

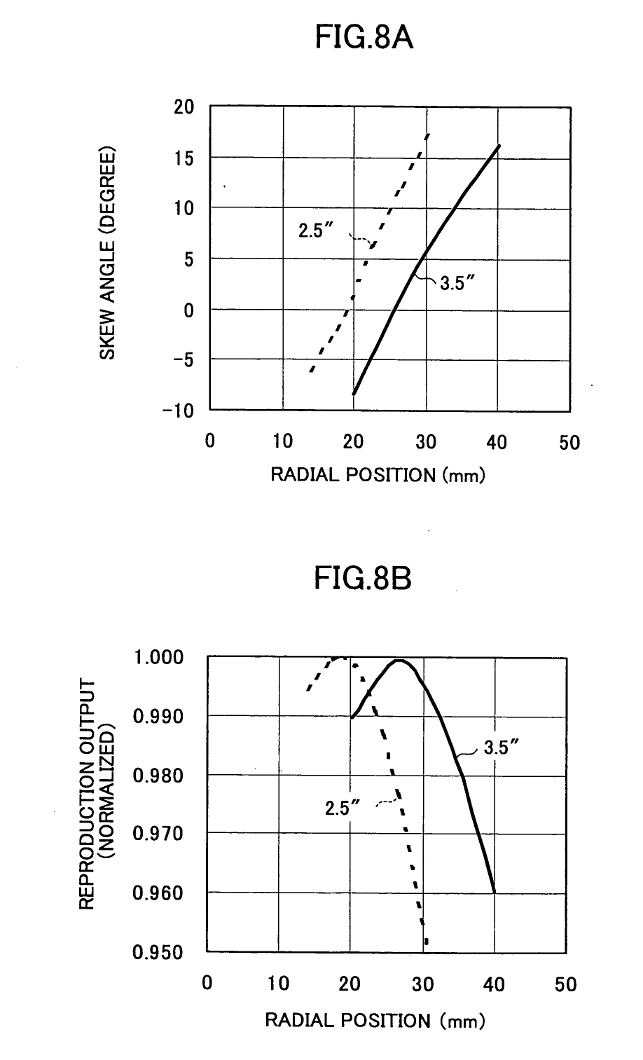

The problems in the convention magnetic storage devices are explained with reference to FIG. 8A and FIG. 8B. FIG. 8A is a graph of skew angle as a function of radial position of the magnetic head, and FIG. 8B is a graph of reproduction output as a function of radial position of the magnetic head.

As illustrated in FIG. 8A, the angle between the width of the sensor element 33 and the width of the track 38 (skew angle) changes depending on the radial position of the magnetic head 28. In the conventional 3.5-inch magnetic disk, the angle varies from −9 degrees to +17 degrees. The conventional 2.5-inch magnetic disk also exhibits a similar range of angle change. If the recording layer of the magnetic disk is formed as a successive metal thin film, the reproduction output varies about 5%, as illustrated in FIG. 8B, even if the azimuth angle (between D_{EL} and Dc shown in FIG. 2) of the magnetic head 28 is optimized. With a conventional patterned medium having an array of magnetic dots arranged in a fixed direction, deviation from the correct timing for detecting the maximum magnetic leakage flux from the individual magnetic dots varies depending on the radial position. This results in further increase of fluctuation of the reproduction output, and the S/N ratio is degraded more seriously.

In contrast, with the present invention, the magnetic dot array is arranged such that the dot aligning direction Ddot of the magnetic dots 46 is always consistent with the width direction D_{EL} of the sensor element 33. The detection timing of the sensor element 33 for detecting the maximum magnetic leakage fluxes from the magnetic dots 46 is stable regardless of the radial position on the magnetic disk 23, and the fluctuation of the reproduction output is prevented. The S/N ratio is improved, as compared with the conventional patterned media, and high-density recording is realized.

The magnetic dot arrays shown in FIG. 5 through FIG. 7 are only examples. The positional relation between the width of the sensor element 33 and the width of the track 38 may be different from those examples shown in FIG. 5 through FIG. 7, as long as the magnetic dots 46 are arranged such that the dot aligning direction Ddot is consistent with the width of the sensor element 33 of the magnetic head 28.

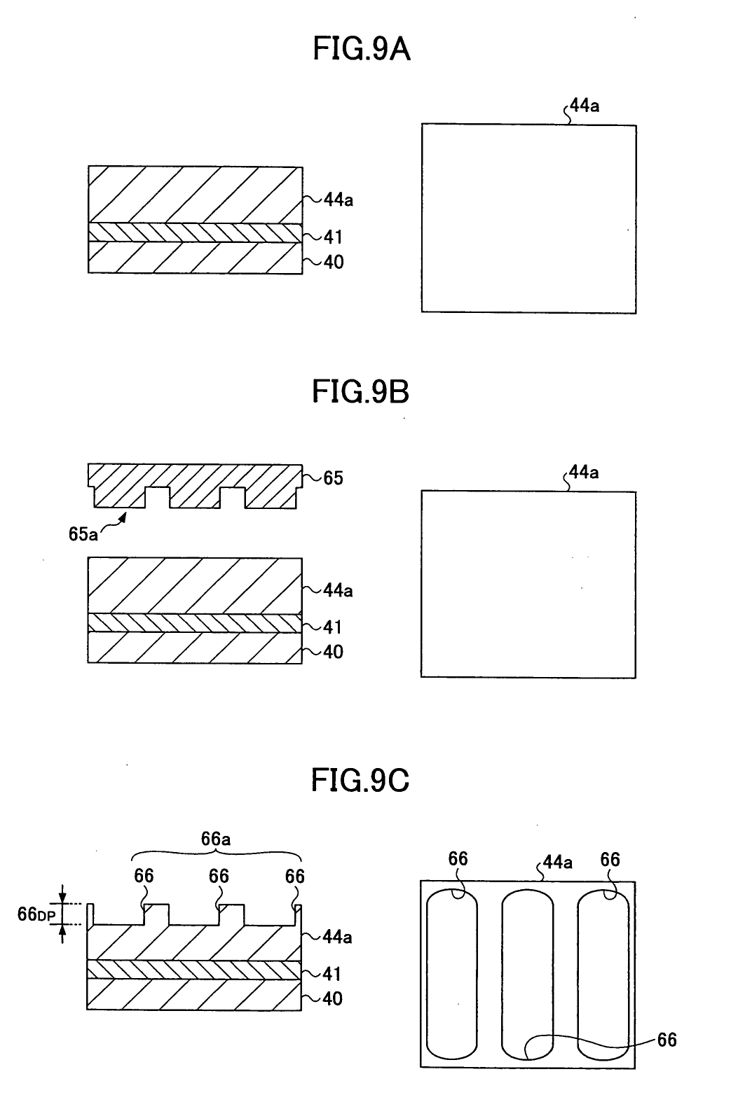

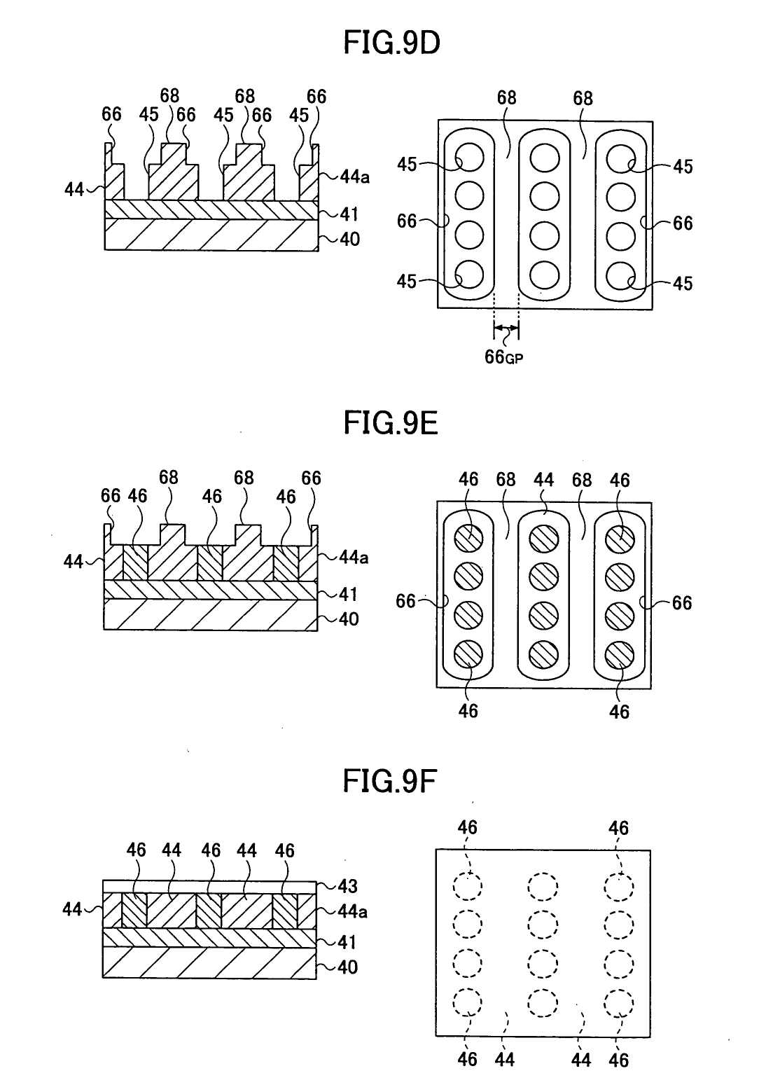

FIG. 9A through FIG. 9F illustrate a fabrication process of the magnetic disk with the above-described magnetic dot array. The left-hand sides of these figures show cross-sectional views, and the right-hand sides show plan views.

In FIG. 9A, a soft magnetic layer 41 with a thickness of 200 nm is formed over a substrate 40 by, for example, electroplating, electroless plating, sputtering, evaporation, or chemical vapor deposition (CVD). From the viewpoint of mass production, electroplating is desirable to form the soft magnetic backing layer 41. When employing an electroplating method with a substrate 40 made of a dielectric material, an underlying layer or a seed layer is formed over the dielectric substrate 40 in advance by, for example, electroless plating or sputtering, using an appropriate metal or alloy.

A metal layer 44a is formed as a nonmagnetic layer 44 over the soft magnetic backing layer 41, up to thickness of, for example, 150 nm. The metal layer 44a is formed of, for example, aluminum by electroplating, electroless plating, sputtering, evaporation, or chemical vapor deposition (CVD). It is desirable to carry out sputtering because a high-purity metal layer 44a can be deposited. When forming an aluminum layer, a sputter target with purity of 99.990% or higher is used. By using a high-purity sputter target, regularity of the nanoholes 45 created in the subsequent step is improved. In the following description, explanation is made on the assumption that the metal layer 44a, as an example of the nonmagnetic layer 44, is an aluminum layer.

In FIG. 9B, a groove pattern is formed in the metal layer 44a using a nickel (Ni) stamper 65. The stamper 65 has a protrusion pattern 65a corresponding to the groove pattern, which is imprinted or transferred onto the metal layer 44a. In place of the nickel stamper 65, a mold may be used.

The nickel stamper 65 is fabricated from a mold (not shown) having a groove pattern corresponding to the protrusion pattern 65a of the nickel stamper 65. The mold is fabricated by coating a glass substrate with a resist film made of photoresist or electron beam resist, producing a latent image of the groove pattern using an electron beam lithograph tool (acceleration voltage of 100 keV) or a deep UV exposure apparatus (wavelength of 257 nm) used to produce an optical master disk, and developing the latent image to create the groove pattern.

Alternatively, a mask may be prepared by an electron beam lithography tool to form the groove pattern in the resist film using the mask and a deep UV exposure apparatus with an optical system for reducing the image scale. The mask can be used repeatedly, and accordingly, the cost required for the lithography can be reduced.

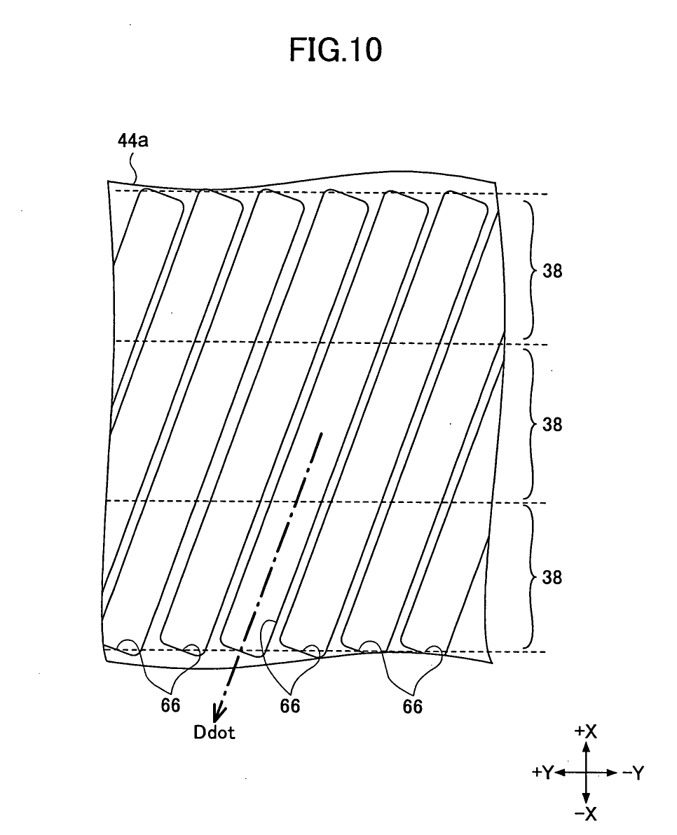

FIG. 10 is a plan view illustrating an example of the groove pattern formed on the metal layer 44a of the magnetic disk 23. An array of magnetic dots 46 shown in, for example, FIG. 5 is to be formed in the grooves.

The groove pattern includes a number of grooves 66 extending parallel to each other in the dot aligning direction Ddot. The length of each groove 66 covers three tracks.

When the mold with the groove pattern is prepared by the above-described process, a nickel film is formed by sputtering over the surface of the mold. This nickel film is used as an electrode. Then, electroplating is carried out using a nickel sulfamate bath to grow a nickel layer up to the thickness of 0.3 mm. The nickel layer is removed from the resist and the glass substrate, the back face of the removed nickel layer is polished, and the nickel stamper 65 is completed.

Returning to FIG. 9B, the nickel stamper 65 is pressed against the metal layer 44a under a pressure of 2.94*10⁹ Pa (3000 kg/cm²) to imprint the reverse pattern of the protrusion pattern 65a onto the surface of the metal layer 44a.

In FIG. 9C, a groove pattern 66a defining the grooves 66 shown in FIG. 10 is formed in the metal layer 44a. Preferably, the depth of the groove 66 is 5 nm to 200 nm, and more preferably, 10 nm to 100 nm, taking into account the subsequent step in which nanoholes are formed in the groove 66. The cross-sectional shape of the groove 66 is not necessarily square, but a V-shaped or semicircular cross-section may be employed.

In FIG. 9D, anodization is carried out on the substrate 40 with the groove pattern 66a obtained in the step shown in FIG. 9C to form nanoholes 45 in the grooves 66. If the metal layer 44a is an aluminum layer, the nanoholes 45 are alumite pores. In this case, the aluminum layer is oxidized, being converted to an aluminum oxide layer. To form nanoholes 45, the structure (the substrate 40 with the groove pattern 66) shown in FIG. 9C is immersed in an electrolytic solution containing sulfuric acid, phosphoric acid or oxalic acid, and a voltage is applied for anodization. To be more precise, the soft magnetic backing layer 41 underneath the metal layer 44a functions as an anodic electrode, a cathode is placed in the electrolytic solution, and a voltage is applied between these two electrodes. If a nonmagnetic layer is inserted between the soft magnetic backing layer 41 and the metal layer 44a, the nonmagnetic layer may be used as the electrode. Through the anodization, a number of nanoholes 45 are formed at a regular interval in a self-organized manner inside the grooves 66.

There is no particular limitation on the anodizing conditions, such as the type, the density, and the temperature of the electrolytic solution, or the anodizing time. These conditions can be appropriately selected depending on the number, the size and the aspect ratio of the nanoholes 45. For example, if the pitch of the nanoholes (i.e., the distance between the centers of two adjacent nanoholes) is 150 nm to 500 nm, diluted phosphoric acid solution is used suitably. If the pitch is 80 nm to 200 nm, then diluted oxalic acid solution is used suitably. At the pitch of 10 nm to 150 nm, it is preferable to use diluted sulphuric acid solution. In either case, the aspect ratio of the nanohole 45 can be further adjusted by immersing the substrate 40 in a phosphoric acid solution after the anodization process to increase the diameter of the nanohole 45.

Preferably, the applied voltage in the anodization process is set so as to satisfy
Voltage [V]=(pitch of nanohole 45 [nm])/A[nm/V]
where the value of A ranges from 1.0 to 4.0.

In FIG. 9E, the nanoholes 45 are filled with a magnetic material to produce magnetic dots 46. The magnetic dots 46 can be formed by deposition of a magnetic material in the nanoholes 45 using electroplating, electroless plating, sputtering, or vacuum evaporation. Among these methods, electroplating is preferable because the nanoholes 45 can be filled satisfactorily. In addition, the grooves 66 are also filled satisfactorily because of good adhesion of the magnetic material to the side walls and the bottom of the groove 66 and to the top face 68 of the metal layer 44a.

Finally, in FIG. 9F, the top face of the structure shown in FIG. 9E is polished to a flat surface. There is no particular limitation on the polishing method, and an arbitrary method can be employed. For example, chemical mechanical polishing (CMP) is employed. Alternatively, a polishing tape coated with abrasive powder (such as alumina powder or diamond powder) may be used. In the latter case, the abrasive face of the polishing tape is pressed against the surface of the structure making use of the pressure of compressed air.

After the polishing, a protection layer 43 is formed over the surface of the disk. The protection layer 43 is, for example, a carbon hydride layer formed by sputtering, chemical vapor deposition (CVD), or a filtered cathodic arc (FCA) method. As necessary, a lubrication layer may be formed over the protection layer 43 by a pulling method or spin coating. In this manner, a magnetic disk is completed.

In this manner the groove pattern 66a formed in the (nonmagnetic) metal layer 44a allows a line of nanoholes 45 to be formed through the anodization process, being aligned at a regular interval in each of the grooves 66. As compared with the conventional nanohole forming technique, in which a recess is formed for creating a single nanohole, a nanohole array can be fabricated efficiently. Because the number of grooves formed in the metal layer 44a is much less than that of the recesses formed in the conventional technique, time required for the electron beam lithography process or the deep UV lithography process can be reduced.

Well-aligned nanoholes 45 are formed in the grooves 66, with much less variation in dot aligning direction Ddot. Consequently, the reproduction output can be increased.

Next, explanation is made of some modifications of the present invention. In the modifications, the same components as those shown in the above-described embodiment are denoted by the same numerical references, and explanation for them is omitted.

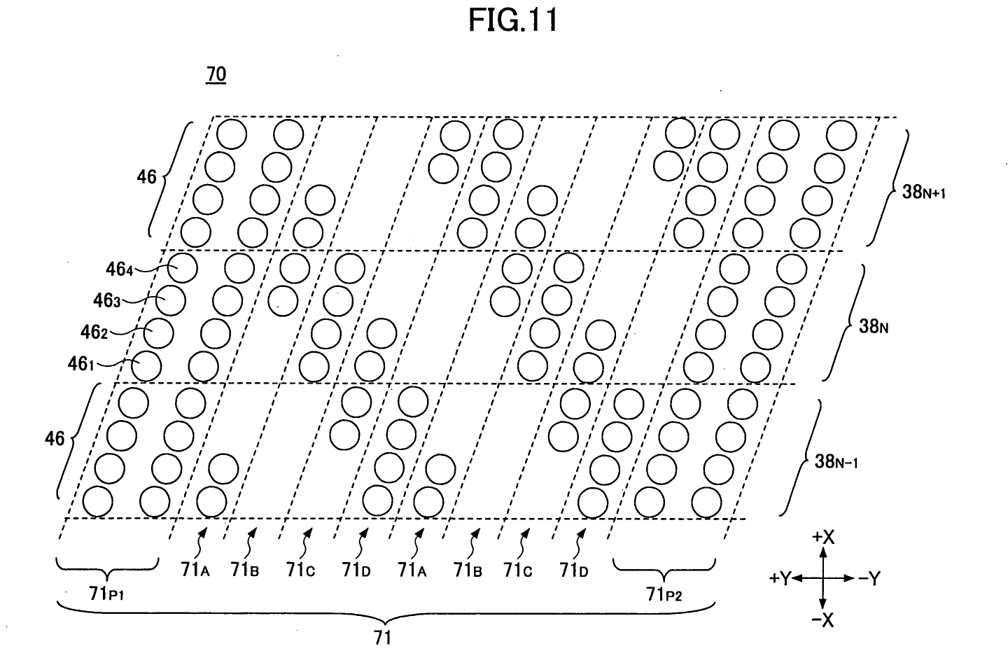

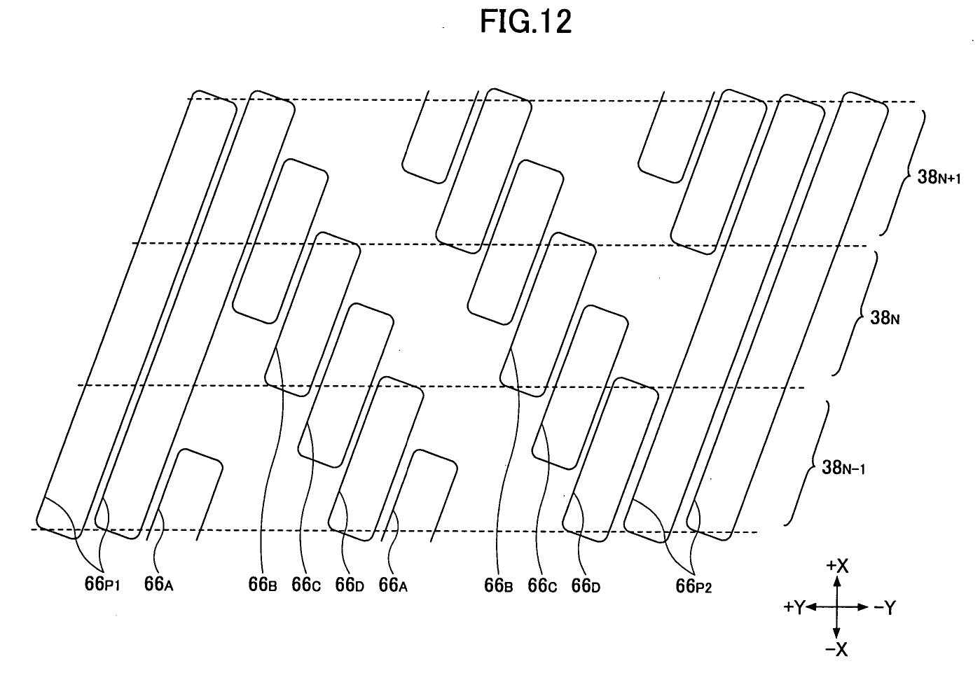

FIG. 11 is a plan view illustrating a first modification of the magnetic storage device. In the first modification, the magnetic storage device has a servo region 70. The servo region 70 illustrated in FIG. 11 is located in the inner circumferential area of the magnetic disk, which area corresponds to that shown in FIG. 5, showing three tracks of servo pattern 71.

The servo pattern 71 of the phase servo of a data-plane servo scheme is defined by a pattern arrangement of magnetic dots 46 in the servo region 70 of the magnetic disk. The data region in which data are recorded is the same as that shown in FIG. 5.

The servo pattern 71 includes a first pad region 71p1, an A region 71A, a B region 71B, a C region 71C, a D region 71D, another A region 71A, another B region 71B, another C region 71C, another D region 71D, and a second pad region 71p2, which are arranged in this order in the Y direction. If the three tracks consisting of the center track 38_{N} (as the reference track) and two adjacent tracks 38_{N-1} and 38_{N+1} cover 360 degrees, line patterns of the magnetic dots 46 are assigned in the A region 71A, the B regions 71B, the C region 71C, and the D region 71D with 90-degree phase shift.

In each of the regions 71A through 71D, four magnetic dots 46₁, 46₂, 46₃ and 46₄ are aligned in the width direction of the track, which is consistent with the width direction of the sensor element 33 of the magnetic head 28, as shown in FIG. 5. With this arrangement, even if the magnetic head is slightly offset from the on-track state, that is, even if the magnetic head slightly deviates from the correct position of track 38N to the adjacent track 38_{N-1} or 38_{N+1} c, fluctuation cased in the reproduction output is at most due to off-tracking, while variations due to other factors can be prevented because the magnetic dots 46 align so as to be parallel to the width of the sensor element 33. Consequently, the phase detection of the dot pattern can be performed accurately, and highly precise servo track control is achieved.

The servo pattern 71 may be modified so as to arrange A region 71A, C region 71C, B region 71B, and D region 71D in this order with 180-degree phase shift.

The servo patterns of the servo regions in the middle and outer circumferential areas are similar to those shown in FIG. 6 and FIG. 7, respectively. In other words, the relation between the dot aligning direction Ddot and the width of the track 38 varies depending on whether the servo pattern is located in the middle or outer circumferential area.

The number of repetitions of A region 71A through D region 71D is appropriately selected. The servo pattern in the servo region is not limited to the example shown in FIG. 11, and any suitable servo pattern may be formed by the dot layout.

The magnetic disk with the servo pattern 71 is fabricated in a similar manner as illustrated in FIG. 9A through FIG. 9F.

First, a soft magnetic backing layer 41 and a metal layer 44a are formed over a substrate 40, as illustrated in FIG. 9A.

Then, a mold for producing a nickel stamper 65 having a protrusion pattern 65a is prepared. The protrusion pattern 65a is a reverse pattern of the groove pattern for the servo pattern 71 shown in FIG. 11.

FIG. 12 is an example of the groove pattern formed in the servo region to create the dot array shown in FIG. 11. The longitudinal axis of the groove 66 extends so as to be parallel to the width of the sensor element 33 of the magnetic head 28. This arrangement allows the magnetic dots to be aligned in the width direction of the sensor element 33. For the pad regions, grooves 66P1 and 66P2 are formed across three tracks. In regions A, B, C, and D, grooves 66A through 66D are formed such that each of the grooves 66A through 66D has a length substantially corresponding to the width of a track 38 and for accommodating four aligned magnetic dots 46. Concerning the grooves 66P1 and 66P2 formed in the pad regions, they may extend across only one or two tracks, or alternatively, across four or more tracks as long as the dot aligning direction is maintained so as to be consistent with the width of the sensor element 33. Similarly, the grooves 66A through 66D formed in regions A through D may be shorter than the width of the track (accommodating less magnetic dots). In this case, two or more grooves are arranged along the width of a track. From the view point of the cost and the efficiency in groove formation, it is desirable to form such a groove that accommodates successive magnetic dots aligned in the same direction. The data region is the same as that shown in FIG. 11.

Returning to FIG. 9B, the nickel stamper 65 fabricated from a mold with a groove pattern is pressed against the metal layer 44a to transfer the protrusion pattern. Thus, the groove pattern 66a shown in FIG. 12 is formed in the servo region of the magnetic disk, as illustrated in FIG. 9C. The steps for forming magnetic dots 46 in the grooves 66 are the same as those shown in FIG. 9D through FIG. 9F.

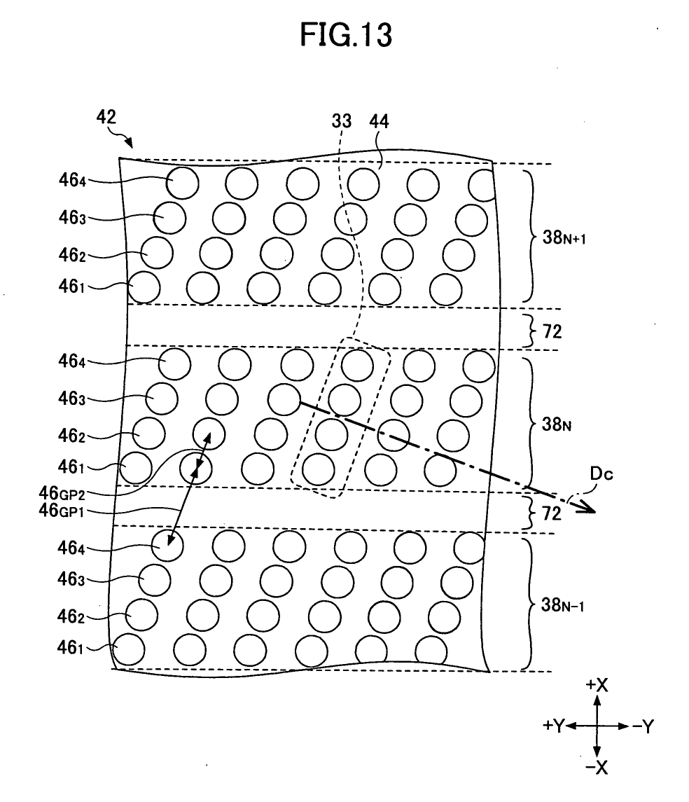

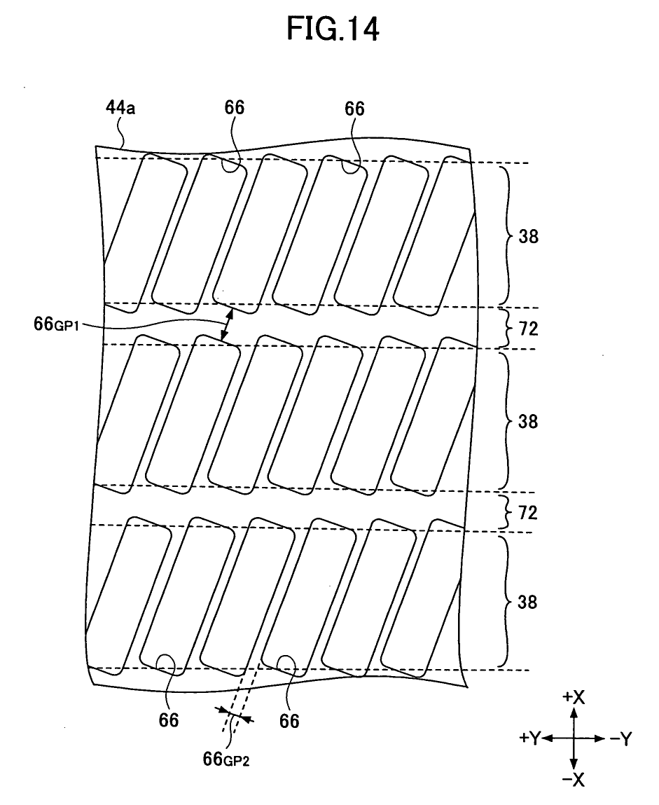

FIG. 13 illustrates a second modification of the magnetic disk according to the embodiment of the invention. The dot arrangement shown in FIG. 13 is provided in the inner circumferential area of the magnetic disk, and corresponds to FIG. 5. The same components as those shown in FIG. 5 are denoted by the same numerical references.

In FIG. 13, a guard band 72 is inserted between two adjacent tracks (for example, between track 38_{N} and track 38_{N-1}). Four magnetic dots 46 align in the recording layer 42 across the width of each of the tracks 38_{N-1}, 38_{N} and 38_{N+1}. The magnetic dots 46 are not formed in the guard band 72. This arrangement can prevent side erasing of the recording head, as well as cross writing or cross reading due to off-tracking. The first gap 46_{GP1} between two magnetic dots separated by the guard band 72 (for example, the center-center distance between the magnetic dots 46₁ and 46₄ located in the tracks 38_{N} and track 38_{N-1}) is greater than the second gap 46_{GP2} between two adjacent magnetic dots in the same line within the same track (for example, the center-center distance between the magnetic dots 46₁ and 46₂ located in tracks 38_{N}). Preferably, the inter-track gap 46_{GP1} across the guard band 72 is less than double of in-track gap 46_{GP2}. More preferable, The first gap 46_{GP1} is less than 1.8 times the second gap 46_{GP2}. Nanoholes are prevented from being generated in the guard band 72, and therefore, magnetic dots 46 are not formed in the guard band 72.

The magnetic disk having the magnetic dot pattern of FIG. 13 is fabricated in a similar manner shown in FIG. 9A though FIG. 9F, using the nickel stamper with a different protrusion pattern.

FIG. 14 is an example of the groove pattern formed in the metal layer 44a of the magnetic disk prior to producing the array of magnetic dots 46. Grooves 66 defining the dot aligning direction Ddot are arranged in parallel to each other. Each of the grooves 66 extends across the width of a track. A groove 66 in one track is separated from a groove 66 of the adjacent track by gap 66_{GP1}. The gap 66_{GP1} is set such that the magnetic dots 46 of two adjacent tracks are separated by the guard band 72 at gap 46_{GP1}. The gap 66_{GP1} is less than or equal to 60 nm, and preferably, 40 nm to 50 nm. This range of gap 66_{GP1} between grooves 66 of two adjacent tracks can prevent nanoholes from being generated in the guard band 72, and therefore, prevent magnetic dots 46 from being formed in the guard band 72.

Preferably, gap 46_{GP2} between two adjacent grooves 66 within a track 38 is set smaller than a gap between two magnetic dots 46 of adjacent lines in the track 38.

With this fabrication process, a parallel groove pattern is formed for each track 38 such that two adjacent groove patterns are separated at gap 66_{GP1}. Consequently, a magnetic disk with a guard band 72 in which magnetic dots are not to be formed is fabricated easily.

Although the present invention has been described using a specific embodiment, the present invention is not limited to the embodiment. There are many modifications and substitutions within the scope of the present invention, which is defined by the appended claims. For example, in place of the combination type magnetic head used in the embodiment, the major magnetic pole of a single-pole type recording head may be used as the sensor element. The shape of the magnetic recording medium is not limited to a disk, and a rectangle or other shapes may be employed. The present invention is applicable to magnetic tapes and magnetic cards.

This patent application is based on and claims the benefit of the earlier filing date of Japanese Patent Application No. 2004-257471 filed Sep. 3, 2004, the entire contents of which are incorporated herein by reference.

What is claimed is:

1. A magnetic recording medium comprising:
a substrate; and
a recording layer formed over the substrate, the recording layer having a nonmagnetic base and a plurality of magnetic dots formed in the nonmagnetic base, the magnetic dots being aligned in a prescribed direction for each track or each group of adjacent tracks of the magnetic recording medium.

2. The magnetic recording medium of claim 1, wherein the magnetic dots align in a direction tilting at a prescribed angle with respect to a width of the track.

3. The magnetic recording medium of claim 1, wherein each of the magnetic dots is of a nano-scale and extends substantially perpendicular to a surface of the nonmagnetic base.

4. The magnetic recording medium of claim 1, wherein the substrate is a disk substrate, and the track is a circular or helical track with a center substantially consistent with a center of the disk substrate.

5. The magnetic recording medium of claim 1, further comprising:
an inter-track region located between two adjacent tracks, in which region the magnetic dots are not formed.

6. The magnetic recording medium of claim 5, wherein the magnetic dots are aligned in the recording layer such that a first gap between two adjacent magnetic dots belonging to two adjacent tracks separated by the inter-track region is greater than a second gap between two adjacent magnetic dots aligned in a same track.

7. The magnetic recording medium of claim 1, wherein the magnetic dot is a perpendicularly magnetized thin film made of a magnetic maternal selected from a group consisting of Fe, Co, Ni, Fe-based alloy, Co-based alloy, and Ni-based alloy.

8. The magnetic recording medium of claim 7, further comprising:
a soft magnetic backing layer between the substrate and the recording layer.

9. The magnetic recording medium of claim 8, further comprising:
a nonmagnetic intermediate layer between the soft magnetic backing layer and the recording layer.

10. The magnetic recording medium of claim 1, further comprising:
a soft magnetic layer at a bottom of each of the magnetic dots.

11. The magnetic recording medium of claim 10, further comprising:
a nonmagnetic layer between the magnetic dot and the soft magnetic layer.

12. A magnetic storage device comprising:
a magnetic recording medium having a recording layer formed on a substrate, the recording layer including a nonmagnetic base and a plurality of magnetic dots formed in the nonmagnetic base; and
a magnetic head having a sensor element for detecting information recorded in the magnetic dots; wherein the magnetic dots are aligned in a direction consistent with a width direction of the sensor element of the magnetic head in each track or each group of adjacent tracks.

13. The magnetic storage device of claim 12, wherein each of the magnetic dots is of a nano-scale and extends substantially perpendicular to a surface of the nonmagnetic base.

14. The magnetic storage device of claim 12, wherein the recording medium is a magnetic disk, and the track is a circular or helical track with a center substantially consistent with a center of the magnetic disk, the magnetic storage device further comprising:
an actuator configured to support and rotate the magnetic head over the magnetic disk.

15. The magnetic storage device of claim 12, wherein the magnetic recording medium has an inter-track region between two adjacent tracks, in which region the magnetic dots are not formed.

16. The magnetic storage device of claim 15, wherein the magnetic dots are aligned in the recording layer of the magnetic recording medium such that a first gap between two adjacent magnetic dots belonging to two adjacent tracks separated by the inter-track region is greater than a second gap between another two adjacent magnetic dots aligned in a same track.

17. The magnetic recording medium of claim 12, wherein the track has a servo region, in which a servo pattern is formed by the magnetic dots.

18. The magnetic recording medium of claim 17, wherein the servo pattern is a phased servo pattern.

19. A method for fabricating a magnetic recording medium comprising the steps of:
forming a nonmagnetic layer over a substrate;
forming a groove pattern in the nonmagnetic layer, the groove pattern consisting of a plurality of grooves, each groove having a longitudinal axis extending in a prescribed direction;
forming one or more nanoholes in each of the grooves along said longitudinal axis such that each of the nanoholes extends substantially perpendicular to a top face of the nonmagnetic layer; and
filling each of the nanoholes with a magnetic material to form magnetic dots.

20. The method of claim 19, wherein the prescribed direction in which the longitudinal axis of the groove extends is set for each track or each group of adjacent tracks to be defined on the magnetic recording medium.

21. The method of claim 19, wherein the nonmagnetic layer is a metal layer, and the nanoholes are formed at a prescribed interval in each of the grooves in a self organized manner through an anodization process.

22. The method of claim 21, wherein the prescribed interval is controlled by regulating an applied voltage in the anodization process.

23. The method of claim 22, wherein the prescribed interval is a function of the applied voltage expressed as a product of the applied voltage [V] and a constant A [nm/V], where A ranges from 1.0 to 4.0.

24. The method of claim 21, wherein the prescribed interval of the nanoholes is set smaller than a gap between two adjacent grooves.

25. The method of claim 19, wherein the groove pattern is formed by pressing a first mold having a protrusion pattern corresponding to the groove pattern against the nonmagnetic layer.

26. The method of claim 25, further comprising the steps of:
preparing a second mold having a second groove pattern corresponding to the protrusion pattern; and
fabricating the first mold using the second mold.

27. A method of fabricating a magnetic recording medium used in a magnetic storage device having a magnetic head with a sensor element for reproducing information from the magnetic recording medium; the method comprising the steps of:
forming a recording layer over a substrate;
forming a plurality of magnetic dots in the recording layer such that the magnetic dots are aligned in a direction substantially consistent with a width direction of the sensor element of the magnetic head.
